(19) United States
(12) Patent Application Publication
(10) Pub. No.: US 2013/0344361 A1
(43) Pub. Date: Dec. 26, 2013

(54) Energy Store Unit Having Two Separate Electrochemical Areas

(71) Applicant: Arpad IMRE, Vaihingen (DE)

(72) Inventor: Arpad IMRE, Vaihingen (DE)

(73) Assignee: Robert Bosch GmbH, Stuttgart (DE)

(21) Appl. No.: 13/923,623

(22) Filed: Jun. 21, 2013

(30) Foreign Application Priority Data
Jun. 22, 2012 (DE) 102012210611.1

(51) Int. Cl. H01M 2/10

(52) U.S. Cl. CPC H01M 2/1072
USPC 429/90; 429/157

(57) ABSTRACT

An electrochemical energy store, including, for example, a battery or a rechargeable battery, having a first electrochemical unit having a first anode, a first cathode, and a first power terminal, which is electrically conductively connected to the first cathode, a second electrochemical unit having a second anode, a second cathode, and a second power terminal, which is electrically conductively connected to the second anode, and having a housing having a first housed area, in which the first electrochemical unit is situated, a second housed area, in which the second electrochemical unit is situated, and a partition wall, which separates the first housed area from the second housed area. The anode of the first electrochemical unit is electrically conductively connected to the cathode of the second electrochemical unit.

### RELATED APPLICATION INFORMATION

The present application claims priority to and the benefit of German patent application no. 10 2012 210 611.1, which was filed in Germany on Jun. 22, 2012, the disclosure of which is incorporated herein by reference.

### FIELD OF THE INVENTION

The present invention relates to an electrochemical energy store and a use thereof.

### BACKGROUND INFORMATION

In the automobile industry, the requirements for the service life, the safety, and the reliability of novel concepts for rechargeable energy stores or traction batteries have been clearly defined. Accordingly, safer and more reliable operation of the traction battery over its lifetime is an essential aspect for the acceptance of a traction battery or a traction battery concept. Cost aspects still primarily remain in the foreground, because an electric vehicle is currently still substantially more expensive than a conventional vehicle having an internal combustion engine. It is predicted that the final assembly of battery packs for installation in an electric vehicle will be carried out in the future close to the locations of customers, who are usually not located in a low-wage country. Therefore, a further reduction of the outlay and the costs for the assembly of a battery system pack and therefore a reduction of the system complexity of an electrochemical energy store configured as a battery pack are desirable.

DE 10 2009 046 505 A1 discloses a method for connecting a battery pole of a first battery cell to a battery pole of a second battery cell and a battery having battery cells connected to one another according to the method. The first battery pole has a lug element configured as an integral component thereof, which implements a direct and immediate electrically conductive connection, i.e., without the interconnection of further components, in an integrally joined or force-locked and form-fitted manner, having low contact resistance to the second battery pole. In this way, n battery single cells may be electrically conductively connected with the aid of (n-1) lug elements to form a battery pack (n is an integer greater than or equal to 2 therein).

### SUMMARY OF THE INVENTION

The present invention provides an electrochemical energy store having the features described herein and a use thereof according to the description herein. Advantageous specific embodiments of the electrochemical energy store are the subject matters of the further descriptions herein.

An electrochemical energy store, for example, a battery or a rechargeable battery, includes the following: a first electrochemical unit having a first anode, a first cathode, and a first power terminal, which is electrically conductively connected to the first cathode, and a second electrochemical unit having a second anode, a second cathode, and a second power terminal, which is electrically conductively connected to the second anode. Furthermore, the energy store includes a housing having a first housed area, in which the first electrochemical unit is situated, a second housed area, in which the second electrochemical unit is situated, and a partition wall, which separates the first housed area from the second housed area. The anode of the first electrochemical unit is electrically conductively connected to the cathode of the second electrochemical unit.

The present invention has the advantage that the complexity of the electrochemical energy store according to the present invention, which includes two electrochemical units, is reduced by the integration of the two electrochemical units into a shared housing and therefore the installation outlay and the costs for the assembly of the elements of the energy store according to the present invention are reduced in comparison to conventional energy stores, in which only one electrochemical unit is contained in each housing.

The anode of the first electrochemical unit or the cathode of the second electrochemical unit may be electrically conductively connected to the housing. The housing is thus at a defined intermediate potential, which is between the potential of the first power terminal and the potential of the second power terminal.

The energy store may include an intermediate voltage terminal for checking the voltage of the potential of the anode of the first electrochemical unit or the cathode of the second electrochemical unit. The intermediate voltage terminal allows monitoring of the voltage of the first or second electrochemical unit and power equalization between the two electrochemical units.

In a first specific embodiment, the intermediate voltage terminal is configured to be electrically insulated in relation to the housing or the first and/or second housing area. In an alternative specific embodiment thereto, the intermediate voltage terminal is electrically conductively connected to the housing or the first and/or second housing area, the housing in particular being able to be configured as electrically conductive. In the latter specific embodiment, the potential of the intermediate voltage terminal defines the potential of the housing.

The partition wall may be configured in such a way that ion transport, liquid transport, and/or pressure equalization are suppressed between the first electrochemical unit or the first housed area and the second electrochemical unit or the second housed area. The first and the second electrochemical units are thus essentially decoupled from one another during operation.

In one specific embodiment, the first electrochemical unit may be essentially identical with respect to its type and its electrical properties to the second electrochemical unit. This embodiment allows simple and systematic assembly of energy stores according to the present invention to form packs made of the energy stores according to the present invention.

In one alternative specific embodiment thereto, the first electrochemical unit may, of course, also substantially differ with respect to its type and its electrical properties from the second electrochemical unit.

In an electrochemical energy store, a passive electrical safety element may be connected according to one of the following possibilities to increase the operational safety: (i) between the anode of the first electrochemical unit and the cathode of the second electrochemical unit, and/or (ii) between the cathode of the first electrochemical unit and the first power terminal of the first electrochemical unit, and/or (iii) between the anode of the second electrochemical unit and the second power terminal of the second electrochemical unit. Two or more passive electrochemical safety elements may also be installed according to two or more of the above-mentioned possibilities in the electrochemical energy store. The passive electrical safety element may in particular be selected from a group which includes a fuse, an element having a positive temperature coefficient, i.e., a so-called PTC element (English: PTC=positive temperature coefficient) and a charge-interrupting element, i.e., a so-called CID element (English: CID=charge-interrupting device).

In one specific embodiment, in the electrochemical energy store, the first electrochemical unit or the first housed area and the second electrochemical unit or the second housed area may be configured as the type of a prismatic electrochemical unit or a prismatic housed area. This embodiment allows the mechanical assembly of multiple electrochemical energy stores essentially without interposed dead volume. The first prismatic electrochemical unit and the second prismatic electrochemical unit may be essentially identical with respect to their geometrical dimensions and may each include a first wall pair, a second wall pair, and a third wall pair of diametrically opposing walls, the surfaces of the walls of the first wall pair being larger than or of identical size to the surfaces of the walls of the second wall pair, and the surfaces of the walls of the second wall pair being larger than or identical in size to the surfaces of the walls of the third wall pair. Furthermore, one wall of a wall pair, which is selected from the first, second, and third wall pairs, of the first electrochemical unit and a corresponding wall from a wall pair, which is selected from the corresponding first, second, or third wall pair, of the second electrochemical unit may either be in contact with one another or may each be in contact with the partition wall.

In one alternative specific embodiment thereto, in the electrochemical energy store, the first electrochemical unit or the first housed area and the second electrochemical unit or the second housed area may be configured as a type of a cylindrical electrochemical unit or a cylindrical housed area. The first cylindrical electrochemical unit may include a first and a second circular end face and also the second cylindrical electrochemical unit may include a first and a second circular end face. The second circular end face of the first cylindrical electrochemical unit and the first circular end face of the second cylindrical electrochemical unit may have an essentially identical diameter and may either be in contact with one another or may each be in contact with the partition wall. Alternatively or additionally thereto, the first cylindrical electrochemical unit may include a cylinder wall and the second cylindrical electrochemical unit may also include a cylinder wall, the first and the second cylinder walls having essentially identical length and either being in contact with one another or each being in contact with the partition wall.

The above-described electrochemical energy store may be used as a rechargeable traction battery in a motor vehicle.

An electrochemical energy store according to the present invention has the following advantages:
In relation to conventional electrochemical energy stores, in which each individual electrochemical unit has two external power terminals for the positive electrical pole and the negative electrical pole, an electrochemical energy source according to the present invention achieves a higher specific energy or a higher specific power than a battery system, specifically due to a lower weight or saved weight of electrochemically inactive components.
The complexity of the contacting outlay from the system aspect per energy store is reduced. In particular, the number of the required external power terminals, which are frequently configured in the form of contact surfaces, is halved. An installation outlay is accordingly also halved.
For some arrangements of the two housed areas, it is possible to situate one power terminal 24, 44 centered per housed area 20, 40, for example, as in the specific embodiments shown in FIGS. 5, 6, and 7. Torsion forces on the power terminals may thus be reduced, which in turn allows a structurally simpler insulation of the power terminal in relation to housing 12.
For electrochemical energy stores according to the present invention, the outlay for the temperature detection in the electrochemical units is also reduced, inter alia, in that it is possible for the energy stores according to the present invention to detect the temperature in only one of the two electrochemical units and to rely on the fact that the temperature in the particular other housed area is close to the detected temperature due to the immediate proximity of the shared partition wall. This means that only one temperature sensor is sufficient for each two electrochemical units.
The electrical insulation outlay is reduced, because only two external power terminals 24, 44 are required for each two electrochemical units 22, 42.
The mechanical contacting outlay, in particular for a cell mount, is reduced in the energy store according to the present invention having the composite of two electrochemical units in one system.
A thermal contacting outlay for cooling or heating systems is also reduced for an energy store according to the present invention.
The outlay and the costs for the construction or the assembly (installation) of an electrochemical energy store according to the present invention are also reduced.
The mechanical stability of the double cell implemented in the energy store according to the present invention, including two housed areas, is increased in relation to two separate single cells or electrochemical units having equal energy content overall.
Two electrical feedthroughs through the housing wall for the external power terminals are saved per energy store according to the present invention, i.e., per double cell. The probability of a leak at the feedthroughs is thus reduced.
The direct proximity of two electrochemical units in one energy store according to the present invention allows better thermal coupling between the two electrochemical units in a double cell according to the present invention in comparison to two typical electrochemical units each configured as a separate cell.
The inductance of the overall system is also reduced in an energy store according to the present invention in comparison to a structure having two single cells. This aspect is particularly important for concepts of rechargeable energy stores, for example, battery direct inverters.
The concept of the electrochemical energy store according to the present invention may be applied to any type of electrochemistry or cell chemistry, to any formula of the anode, the cathode, or the electrolyte, and to any arbitrary geometry of a housed area or an electrochemical unit (e.g., cylindrical or prismatic).
Due to the above-mentioned advantages, it is to be expected that overall the reliability of an energy store according to the present invention and thus also its service life will be increased in comparison to conventional electrochemical units having battery single cells.
The total system costs, the total system installation outlay, and the total system weight of an electrochemical energy store according to the present invention are also reduced in comparison to conventional battery packs constructed from single cells, which is advantageous for automotive, stationary, and also other energy store systems.

The present invention will be explained in greater detail hereafter as an example on the basis of specific embodiments of the present invention shown in the appended figures.

### BRIEF DESCRIPTION OF THE DRAWINGS

FIG. 1 shows a schematic view of a first specific embodiment of an electrochemical energy store according to the present invention.

FIG. 2 shows a schematic view of a second specific embodiment of an electrochemical energy store according to the present invention.

FIG. 3 shows a schematic view of a third specific embodiment of an electrochemical energy store according to the present invention.

FIG. 4 shows a schematic view of an electrochemical energy store according to the present invention having prismatic first and second housed areas in a first embodiment variant.

FIG. 5 shows a schematic view of an electrochemical energy store according to the present invention having prismatic first and second housed areas in a second embodiment variant.

FIG. 6 shows a schematic view of an electrochemical energy store according to the present invention having prismatic first and second housed areas in a third embodiment variant.

FIG. 7 shows a schematic view of an electrochemical energy store according to the present invention having cylindrical first and second housed areas in a first embodiment variant.

FIG. 8 shows a schematic view of an electrochemical energy store according to the present invention having cylindrical first and second housed areas in a second embodiment variant.

### DETAILED DESCRIPTION

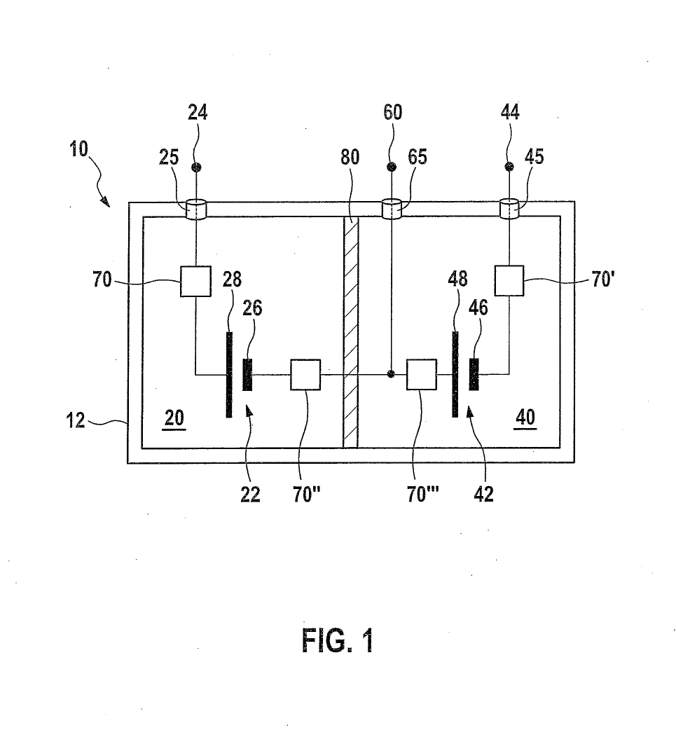

The specific embodiments of an electrochemical energy store 10 according to the present invention shown in FIGS. 1 through 3 share the feature that they include the following: a first electrochemical unit 22, which includes a first anode 26, a first cathode 28, and an external first power terminal 24, which is electrically conductively connected to first cathode 28 during operation, and is situated in a first housed area 20 of a housing 12, a second electrochemical unit 42, which includes a second anode 46, a second cathode 48, and a second power terminal 44, which is electrically conductively connected to second anode 46 during operation, and is situated in a second housed area 40 of housing 12, housing 12 having first housed area 20, in which as mentioned first electrochemical unit 22 is situated, second housed area 40, in which as mentioned second electrochemical unit 42 is situated, and a partition wall 80, which separates first housed area 20 from second housed area 40. In electrochemical energy store 10, anode 26 of first electrochemical unit 22 is electrically conductively connected to cathode 48 of second electrochemical unit 42. This electrically conductive connection connects mentioned electrochemical elements 26 and 48, which are situated in first and second housed area 20 and 40, respectively. This electrical connection may be guided through partition wall 80, as shown in FIGS. 1 through 3, or may extend along or in a wall of housing 12 while bypassing partition wall 80 (not shown).

Partition wall 80, which spatially separates first housed area 20 or first electrochemical unit 22 from second housed area 40 or second electrochemical unit 42, is configured and connected to the housing in such a way that ion transport, liquid exchange, and pressure equalization between the two areas 20, 40 or the two electrochemical units 22 and 42 are suppressed.

External first power terminal 24 and external second power terminal 44 represent the two poles, i.e., the positive electrical pole and the negative electrical pole, of energy store 10 according to the present invention. During operation of energy store 10, at least one external power consumer (not shown) or an external battery charging and/or discharging device (also not shown) are connected to these power terminals 24 and 44. For this purpose, first power terminal 24 and second power terminal 44, which are also referred to as power connections, are configured in such a way that they are suited for the purpose of transmitting a maximum charging or discharging current specified for the energy store according to the present invention, i.e., power terminals 24 and 44 are so-called high-power capable. The electrically conductive connections between first power terminal 24 and first cathode 28 and between second power terminal 44 and second anode 46 are each guided through a wall of housing 12 in such a way that the feedthrough of the corresponding electrical conductor for establishing the electrically conductive connection is electrically insulated in relation to housing 12. For this purpose, the corresponding electrical conductors are guided through electrical insulating arrangement 25 and 45 inserted into the corresponding wall of housing 12.

The electrically conductive connection from first anode 26 of first electrochemical unit 22 to cathode 48 of second electrochemical unit 42 is at an electrical intermediate potential, which is between the positive pole potential and negative pole potential applied to first power terminal 24 and second power terminal 44. This intermediate potential is connected via an electrically conductive connection to an external intermediate voltage terminal 60, the latter electrically conductive connection connecting intermediate voltage terminal 60 to the electrically conductive connection between first anode 26 and second cathode 48, as shown in FIGS. 1 through 3. Alternatively thereto, in the specific embodiments shown in FIGS. 1 through 3, intermediate voltage terminal 60 may also be electrically conductively connected directly either to first anode 26 of first electrochemical unit 22 or to second cathode 48 of second electrochemical unit 42 (not shown).

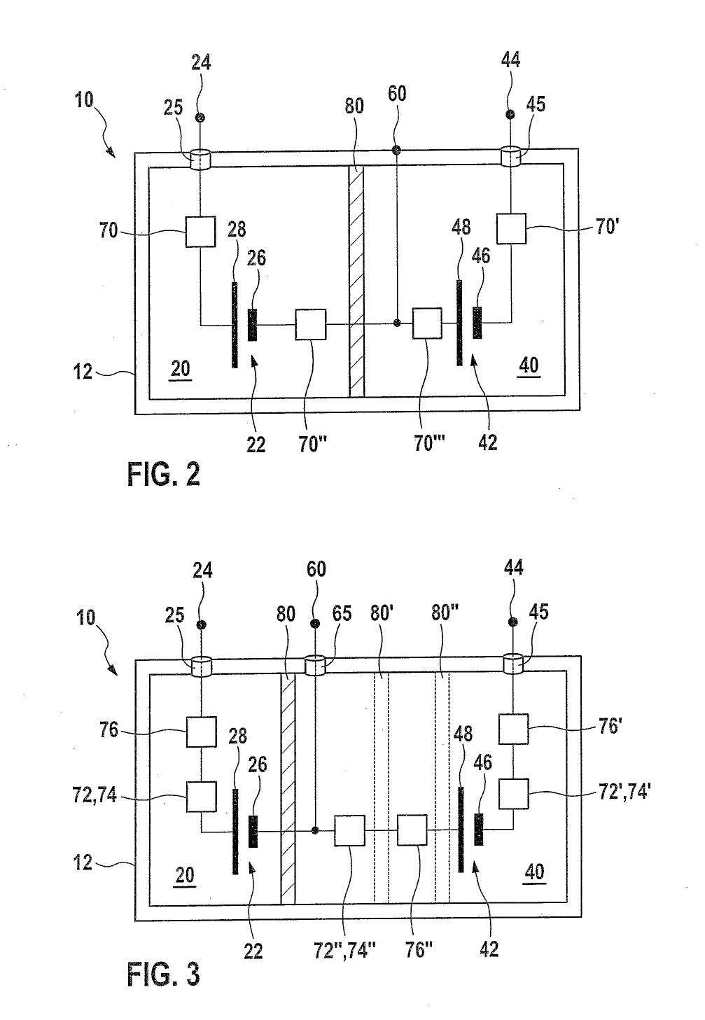

The first and second specific embodiments of electrochemical energy store 10 according to the present invention shown in FIGS. 1 and 2, respectively, differ due to an electrical insulation (see electrical insulating arrangement 65 in FIG. 1) and an electrically conductive connection (as indicated in FIG. 2) between intermediate voltage terminal 60 and housing 12.

In the first specific embodiment shown in FIG. 1, the electrical conductor to intermediate voltage terminal 60 is electrically insulated with the aid of an electrical insulating arrangement 65 in relation to housing 12 and is guided through electrical insulating arrangement 65 for this purpose, without being in contact with housing 12. In a similar way, in the third specific embodiment of energy store 10 shown in FIG. 3, the electrical feed line to intermediate voltage terminal 60 is also electrically insulated with the aid of electrical insulating arrangement 65 in relation to housing 12.

In the second specific embodiment of electrochemical energy store 10 according to the present invention shown in FIG. 2, intermediate voltage terminal 60 and the electrical feed line connected thereto is in electrically conductive contact with housing 12, i.e., housing 12 is set to the intermediate potential, which is also applied to intermediate voltage terminal 60. In this case, housing 12 may be configured as electrically conductive or made of an electrically conductive material, whereby housing 12 is at a defined electrical potential (the intermediate potential). The embodiment of intermediate voltage terminal 60 shown in FIG. 2 may also be used in the third specific embodiment shown in FIG. 3, of course, instead of the embodiment showed therein having the electrical insulation of intermediate terminal 60 in relation to housing 12.

To increase the operational reliability and in particular as an overcurrent protection to protect electrodes 26 and 28 of first electrochemical unit 22 and electrodes 46 and 48 of second electrochemical unit 42 from a harmful oversized charging or discharging current, and also for overcurrent protection of externally connected electrical devices, electrochemical energy store 10 includes at least one passive electrical safety element or also multiple such safety elements 70, 70′, 70″, 70′″. These may be provided in the internal electrically conductive connection between first power terminal 24 and first cathode 28 and/or between first anode 26 and second cathode 48 and/or between second anode 46 and second power terminal 44, as shown in FIGS. 1 through 3.

A particular passive electrical safety element 70, 70′, 70″, 70′″ is configured for the purpose of limiting or interrupting an electrical current passing through it if the current exceeds a predefined threshold value. A particular passive electrical safety element 70, 70′, 70″, 70′″ shown in FIGS. 1 and 2 may be an element which is selected from a group which includes the following: a fuse 72, which is passive in particular, a PTC element 74, i.e., an element having a positive temperature coefficient (English: PTC=positive temperature coefficient), and a CID element 76, i.e., a charge-interrupting element (English: CID=charge-interrupting device).

In each of the three parts of the electrically conductive connection between first power terminal 24 and second power terminal 44, i.e., in the part between first power terminal 24 and first cathode 28, in the second part between first anode 26 and second cathode 48, and/or in the third part between second anode 46 and second power terminal 44, one or multiple passive electrical safety elements may be provided, for example, a fuse 72 and a PTC element 74 and a CID element 76, as shown in FIG. 3, or also a fuse 72, a PTC element 74, and a CID element 76, which are connected in series (not shown in the figures).

For the specific embodiment of an energy store according to the present invention shown in FIG. 3, three variants are indicated for the arrangement of partition wall 80 and 80′ and 80″. In FIG. 3, partition wall 80 is shown with solid lines and partition walls 80′ and 80″ are shown with dotted lines. The arrangements of partition walls 80, 80′, and 80″ differ due to their location with respect to the passive safety elements (fuse 72″, PTC element 74″ and CID element 76″), which are provided in the electrically conductive connection between first anode 26 in first housed area 20 and second cathode 48 in second housed area 40. In the first variant, partition wall 80 is situated in such a way that the electrically conductive connection between first anode 26 and fuse 72″ extends through partition wall 80, so that fuse 72″, PTC element 74″, and CID element 76′ are situated in second housed area 40. In the second variant, partition wall 80′ is situated in such a way that the electrically conductive connection between fuse 72″, PTC element 74″ and CID element 76″ extends through partition wall 80′, so that fuse 72″ and PTC element 74″ are situated in first housed area 20 and CID element 76′ is situated in second housed area 40. In the third variant, partition wall 80″ is situated in such a way that the electrically conductive connection between CID element 76″ and second cathode 48 extends through partition wall 80″, so that fuse 72″, PTC element 74″ and CID element 76′ are situated in first housed area 20.

Housing 12 may be made of an electrically conductive material or may be coated using an electrically conductive material. Such an electrically conductive embodiment of housing 12 is provided in particular in the second specific embodiment of electrochemical energy store 10 shown in FIG. 2, in which intermediate voltage terminal 60 is in electrically conductive contact with housing 12, so that housing 12 is set to a defined electrical potential, specifically the intermediate potential.

Alternatively thereto, housing 12 may also be made of an electrically nonconductive material, i.e., an electrically insulating material, for example, a plastic. Such an electrically insulating embodiment of housing 12 is provided in particular in the first specific embodiment of electrochemical energy store 10 shown in FIG. 1, in which intermediate voltage terminal 60 (with the aid of electrical insulating arrangement 65) is electrically insulated in relation to housing 12, as are first power terminal 24 and second power terminal 44, in particular with the aid of corresponding electrical insulating arrangement 25 and 45, as shown in FIG. 1.

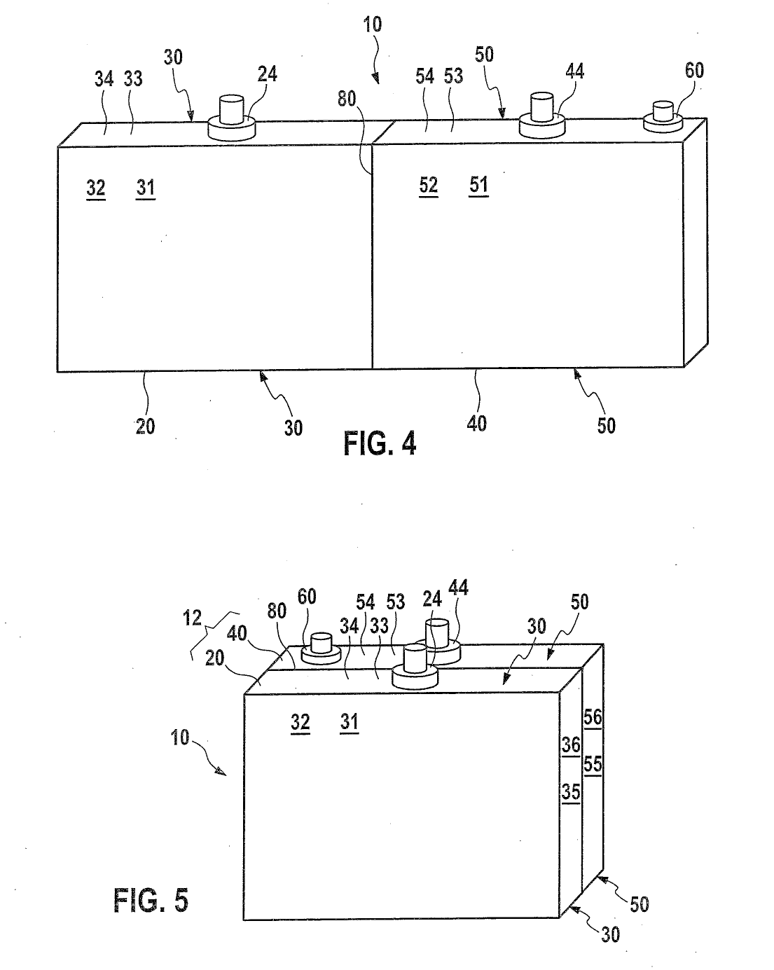

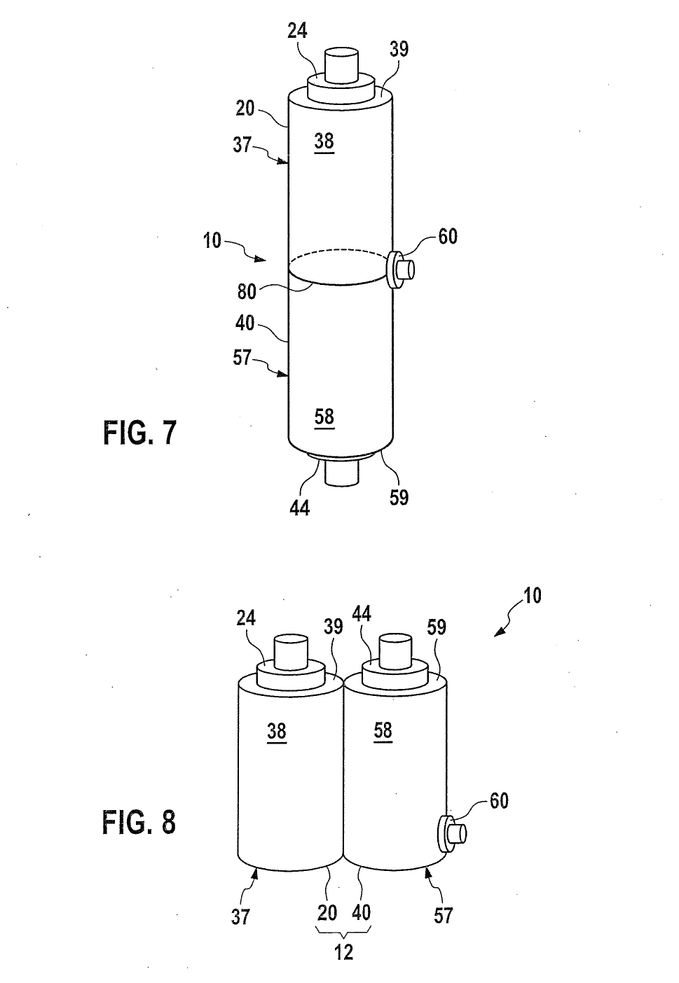

First and second housed areas 20 and 40 or first and second electrochemical units 22 and 42 may be configured as prismatic cells, as shown in FIGS. 4 through 6, or as cylindrical cells, as shown in FIGS. 7 and 8.

In the specific embodiments shown in FIGS. 4 through 6, having prismatic cells or housed areas 20 and 40, a particular cell includes a first wall pair 32, 52 of diametrically opposing walls 31, 31′ and 51, 51′, a second wall pair 34, 54 of diametrically opposing walls 33, 33′ and 53, 53′, and a third wall pair 36, 56 of diametrically opposing walls 35, 35′ and 55, 55′, respectively. For a general prismatic cell, the surfaces of walls 31, 31′, 51, 51′ of first wall pair 32, 52 are larger than the surfaces of walls 33, 33′, 53, 53′ of second wall pair 34, 54, and the surfaces of walls 33, 33′, 53, 53′ of second wall pair 34, 54 are larger than the surfaces of walls 35, 35′, 55, 55′ of third wall pair 36, 56, as shown in FIGS. 4 through 6. Alternatively (not shown in the figures), the surfaces of the walls of the first wall pair may also be essentially identical in size to the surfaces of the walls of the second wall pair or the surfaces of the walls of the second wall pair may be identical in size to the surfaces of the walls of the third wall pair.

In the specific embodiments shown in FIGS. 4 through 6, having prismatic cells, the cells, i.e., first and second housed areas 20 and 40, have essentially identical dimensions.

In the specific embodiment shown in FIG. 4, first housed area 20 and second housed area 40 are situated adjacent to one another in such a way that two walls of third wall pair 36, 56, i.e., the walls of wall pairs 32, 52 having the smallest surfaces, are adjacent to one another. Adjacent walls 35, 55 of third wall pair 36, 56 may either be in direct contact with one another or may even be integrally formed with one another, and in this way form partition wall 80 of energy store 10, as indicated in FIG. 4, or they may alternatively each be in contact with an interposed partition wall (thus not shown).

In the specific embodiment of energy store 10 shown in FIG. 5, walls 31 and 51 of first wall pair 32 of the first cell and walls 51 of first wall pair 52 of the second cell, i.e., the walls of wall pairs 32, 52 having the largest surfaces, are situated adjacent to one another. Wall 31 of first wall pair 32 and wall 51 of first wall pair 52 may either be in direct contact with one another or may be integrally formed with one another and in this way form the partition wall of energy store 10, as indicated in FIG. 5, or they may alternatively each be in contact with an interposed partition wall of the electrochemical energy store (thus not shown).

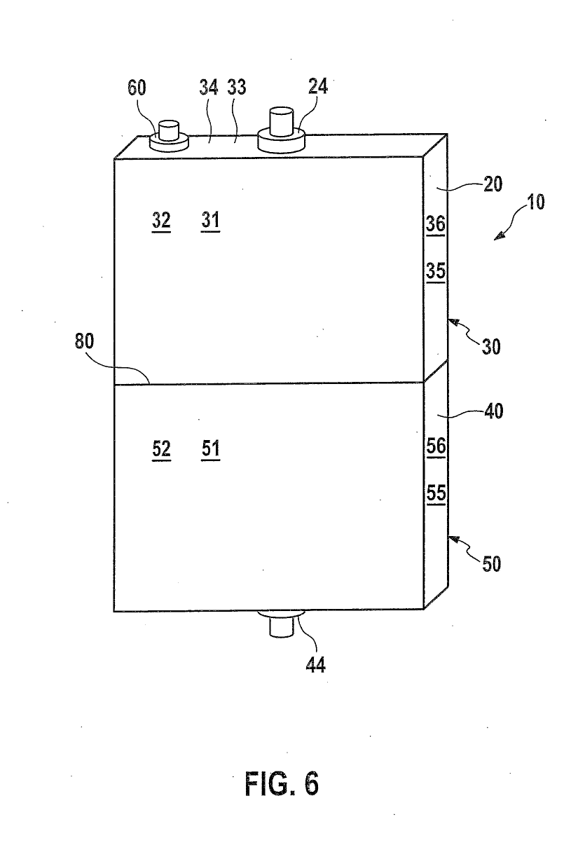

In the specific embodiment of energy store 10 shown in FIG. 6, walls 33 of second wall pair 34 of the first cell and walls 53 of second wall pair 54 of the second cell are situated adjacent to one another. Walls 33, 53 of second wall pairs 34, 54 which are situated adjacent to one another may either be in direct contact with one another or may be formed integrally with one another and in this way form the partition wall of the energy store, or they may alternatively each be in contact with an interposed partition wall of the electrochemical energy store (thus not shown).

In the specific embodiments of energy store 10 according to the present invention shown in FIGS. 7 and 8, having cylindrical cells, a particular cylindrical cell or cylindrical electrochemical unit 37 and 57 has a cylinder wall 38 and 58 and two circular end faces 39, 39′ and 59, 59′, respectively, which are situated diametrically opposite to one another in the longitudinal direction of the cells. In these specific embodiments, the two cylindrical cells have essentially identical dimensions.

In the specific embodiment shown in FIG. 7, a circular end face 39 of first cylindrical electrochemical unit 37 and a second circular end face 59 of second cylindrical electrochemical unit 57 are situated adjacent to one another. They may either be in direct contact with one another or may be integrally formed with one another and in this way form partition wall 80 of energy store 10, as indicated in FIG. 7. Alternatively thereto, the end faces which are situated adjacent may each be in contact with an interposed partition wall (thus not shown).

In the specific embodiment shown in FIG. 8, first and second cell or cylindrical electrochemical units 37 and 57 are situated having longitudinal axes aligned essentially parallel to one another, in such a way that cylinder wall 38 of first unit 37 touches cylinder wall 58 of second unit 57. Cylinder walls 38 and 58 may be in contact with one another or partially interlock in one another or may be partially integrally formed with one another in the area of the contact surface. Alternatively thereto, cylinder walls 38 and 58 may each be in contact with an interposed partition wall (thus not shown).

What is claimed is:

1. An electrochemical energy store, which is a battery or a rechargeable battery, comprising:
a first electrochemical unit having a first anode, a first cathode, and a first power terminal which is electrically conductively connected to the first cathode;
a second electrochemical unit having a second anode, a second cathode, and a second power terminal, which is electrically conductively connected to the second anode; and
a housing having a first housed area, in which the first electrochemical unit is situated, a second housed area, in which the second electrochemical unit is situated, and a partition wall, which separates the first housed area from the second housed area;
wherein the anode of the first electrochemical unit is electrically conductively connected to the cathode of the second electrochemical unit.

2. The electrochemical energy store of claim 1, wherein the anode of the first electrochemical unit or the cathode of the second electrochemical unit is electrically conductively connected to the housing.

3. The electrochemical energy store of claim 1, wherein the energy store includes an intermediate voltage terminal for checking the voltage of the potential of the anode of the first electrochemical unit or the cathode of the second electrochemical unit.

4. The electrochemical energy store of claim 3, wherein the intermediate voltage terminal is electrically insulated in relation to the housing or at least one of the first housing area and the second housing area.

5. The electrochemical energy store of claim 3, wherein the intermediate voltage terminal is electrically conductively connected to the housing or at least one of the first housing area and the second housing area.

6. The electrochemical energy store of claim 1, wherein the partition wall is configured so that at least one of ion transport, liquid transport, and pressure equalization between the first electrochemical unit and the first housed area and the second electrochemical unit and the second housed area are suppressed.

7. The electrochemical energy store of claim 1, wherein the first electrochemical unit is essentially identical with respect to its type and its electrical properties to the second electrochemical unit.

8. The electrochemical energy store of claim 1, wherein the first electrochemical unit substantially differs with respect to its type and its electrical properties from the second electrochemical unit.

9. The electrochemical energy store of claim 1, wherein a passive electrical safety element is connected at least one of between: (i) the anode of the first electrochemical unit and the cathode of the second electrochemical unit, (ii) the cathode of the first electrochemical unit and the first power terminal of the first electrochemical unit, and (iii) the anode of the second electrochemical unit and the second power terminal of the second electrochemical unit.

10. The electrochemical energy store of claim 9, wherein the passive electrical safety element includes at least one of a fuse, an element having a positive temperature coefficient, and a charge-interrupting element.

11. The electrochemical energy store of claim 1, wherein the first electrochemical unit and the first housed area and the second electrochemical unit and the second housed area are of the type of a prismatic electrochemical unit or a prismatic housed area.

12. The electrochemical energy store of claim 1, wherein the first electrochemical unit and the first housed area and the second electrochemical unit and the second housed area are of the type of a cylindrical electrochemical unit or a cylindrical housed area.

13. The electrochemical energy store of claim 11, wherein the first prismatic electrochemical unit and the second prismatic electrochemical unit are essentially identical with respect to their geometrical dimensions and each include a first wall pair, a second wall pair and a third wall pair of diametrically opposing walls,
the surfaces of the walls of the first wall pair being larger than or identical in size to the surfaces of the walls of the second wall pair, and
the surfaces of the walls of the second wall pair being larger than or identical in size to the surfaces of the walls of the third wall pair, and one wall of a wall pair, which is selected from the first, second, and third wall pairs, of the first electrochemical unit and a corresponding wall of a wall pair, which is selected from the corresponding first, second, or third wall pair, of the second electrochemical unit are either in contact with one another or are each in contact with the partition wall.

14. The electrochemical energy store of claim 12, wherein the first cylindrical electrochemical unit includes a first and a second circular end face, and the second cylindrical electrochemical unit includes a first and a second circular end face, the second circular end face of the first cylindrical electrochemical unit and the first circular end face of the second cylindrical electrochemical unit having an essentially identical diameter and are either in contact with one another or are each in contact with the partition wall.

15. The electrochemical energy store of claim 10, wherein the first cylindrical electrochemical unit includes a cylinder wall and the second cylindrical electrochemical unit includes a cylinder wall, the first and the second cylinder walls have essentially identical lengths, and are either in contact with one another or are each in contact with the partition wall.

16. The electrochemical energy store of claim 1, wherein the electrochemical energy store is used as a rechargeable traction battery in a motor vehicle or in a stationary accumulator.
